(19) United States
(12) Patent Application Publication
(10) Pub. No.: US 2007/0296738 A1
(43) Pub. Date: Dec. 27, 2007

(54) MANIPULATING DESKTOP BACKGROUNDS

(76) Inventors: John O. Louch, San Luis Obispo, CA (US); Eric Steven Peyton, Lisle, IL (US)

Correspondence Address: FISH & RICHARDSON P.C., PO BOX 1022, MINNEAPOLIS, MN, 55440-1022, US

(21) Appl. No.: 11/425,654

(22) Filed: Jun. 21, 2006

(51) Int. Cl. G09G 5/00

(52) U.S. Cl. 345/634; 345/619; 345/581

(57) ABSTRACT

Apparatus, methods and systems for manipulating desktop images are described. A method is provided that includes identifying a trigger event; displaying an interface including an image associated with a background of a display environment, the image being displayed in substantially an entire display space of the display environment; receiving user input to either change or transform the image; and updating the background with the changed or transformed image.

### FIELD

The present invention relates generally to displaying graphic images

### BACKGROUND

Many modern operating systems, provide a graphical user interface (GUI) within which users can use and manage their applications. The GUI provides a desktop or, more generally, a display oriented environment which typically contains a variety of visual components including text, icons and windows. The desktop can include image data, sometimes referred to as the desktop background, or background wallpaper, and is typically viewable, at least in part, depending on the number and location of other visual components (i.e., desktop items) that are displayed on top of the desktop background.

Conventional graphical user interfaces offer users rudimentary mechanisms by which to personalize their environment, or otherwise modify the visual characteristics of their computer, including the desktop background. One conventional tool allows a user to select an image to display as the desktop background.

### SUMMARY

Systems, apparatus, methods and computer program products are described below for manipulating a desktop background.

In one aspect a method is provided that includes identifying a trigger event; displaying an interface including an image associated with a background of a display environment, the image being displayed in substantially an entire display space of the display environment; receiving user input to either change or transform the image; and updating the background with the changed or transformed image.

These and other embodiments can optionally include one or more of the following features. Receiving input to transform the image can include input selected from the operations to scale, pan and rotate. Receiving input to transform the image can include input to apply an image operation to the image selected from the group of red-eye reduction, image tinting, captioning, blur, sepia-coloration, mosaic, and filtering. The display environment can be a desktop. The method can include displaying one or more tools for selection by a user to allow for manipulation of the image. The tools can be selected from the group comprising a selection tool and a transformation tool. The tools can be overlaid on the image. The tools can be displayed in a border area of the display environment. The method can include, responsive to receipt of input to change the image, selecting one or more new images and displaying the one or more new images in substantially the entire display space. The method can include receiving input to transform each of the one or more new images independently. The method can include, responsive to the receipt of transformation input, transforming the image and displaying the transformed image in substantially the entire display space. The method can include dismissing the interface; and displaying the changed or transformed image displayed in the interface as the background. The input to transform can include input to identify a portion of the image to be displayed in the background and the method can further include presenting the portion in the background when the interface is dismissed. The input can be a zoom input. Displaying an interface can include a visual transition to introduce the interface. Dismissing the interface can include a visual transition to dismiss the interface.

In another aspect an apparatus features an interface for displaying a desktop image at substantially a size and at an aspect ratio associated with an output device, where the interface includes a selection tool for selecting an image for display and a transformation tool for transforming the image prior to display.

In another aspect a computer program product including instructions tangibly stored on a computer-readable medium is provided. The product includes instructions for causing a computing device to identify a trigger event; display an interface including an image associated with a background of a display environment, the image being displayed in substantially an entire display space of the display environment; receive user input to either change or transform the image; and update the background with the changed or transformed image.

The details of which are described below in full.

These general aspects may be implemented, for example, using a method and an apparatus. An apparatus may include one or more computer readable media having instructions stored thereon and configured to result in one or more of the general aspects being performed. An apparatus may include one or more pieces of structure for performing operations in one or more of the general aspects. A method may include the operations that are performed, or the operations that structure is configured to perform, in one or more of the general aspects.

Particular implementations of these aspects can be implemented to realize one or more of the following advantages. Choosing and manipulating a desktop background image while the image is displayed as large as or near to the total display space allows a user to see the image as it will appear when applied as the desktop background. A user viewing a substantially full-screen image can easily see details of the image: these details may be easily visible when the image is as large as the desktop background, but obscured if the image is displayed in a smaller space (e.g., a large thumbnail). Displaying tools overlaying the image, or in a border area, allow a user to change and manipulate the image without obscuring the image. Displaying the image as it is subject to manipulations and transformations allows a user to see, in full detail, the effect of their manipulations. Selecting and transforming a selected image makes it easy to modify and personalize the desktop background without first having to manipulate, edit or save the image.

The details of one or more implementations are set forth in the accompanying drawings and the description below. Other features will be apparent from the description, the drawings, and the claims.

### DESCRIPTION OF FIGURES

FIG. 1 shows a flow diagram for a process of manipulating a desktop background.

FIG. 2 shows a desktop with icons and application windows with a particular desktop background.

FIG. 3 shows a desktop background manipulation interface.

FIG. 4 shows the desktop background after having been subject to a transformation.

FIG. 5 shows an image selector.

FIG. 6 shows an updated desktop background.

Like reference numbers and designations in the various drawing indicate like elements.

### DETAILED DESCRIPTION

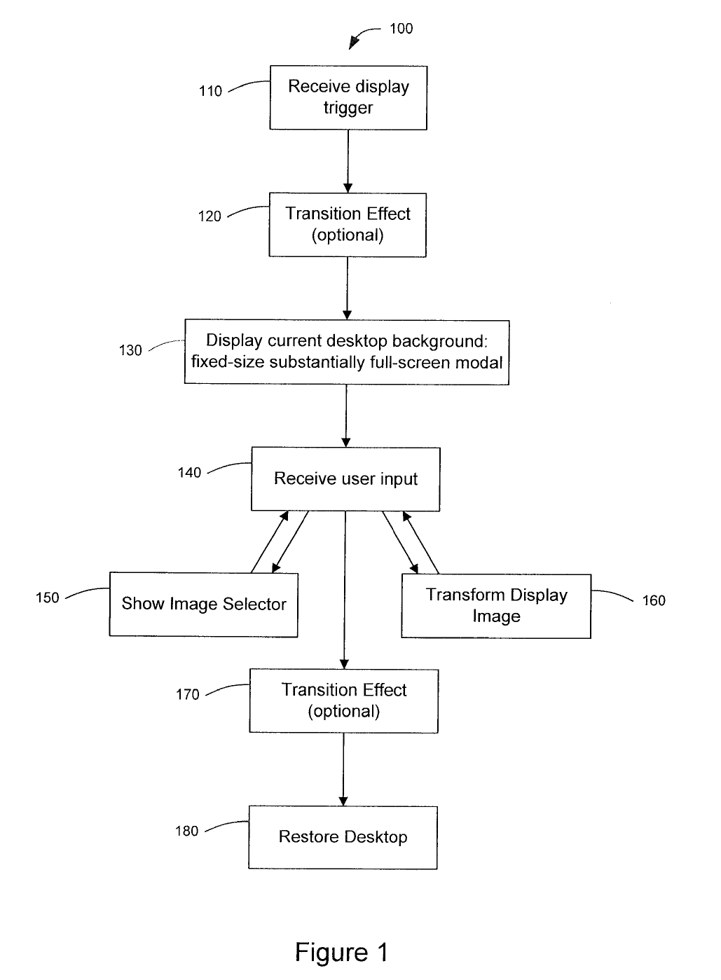

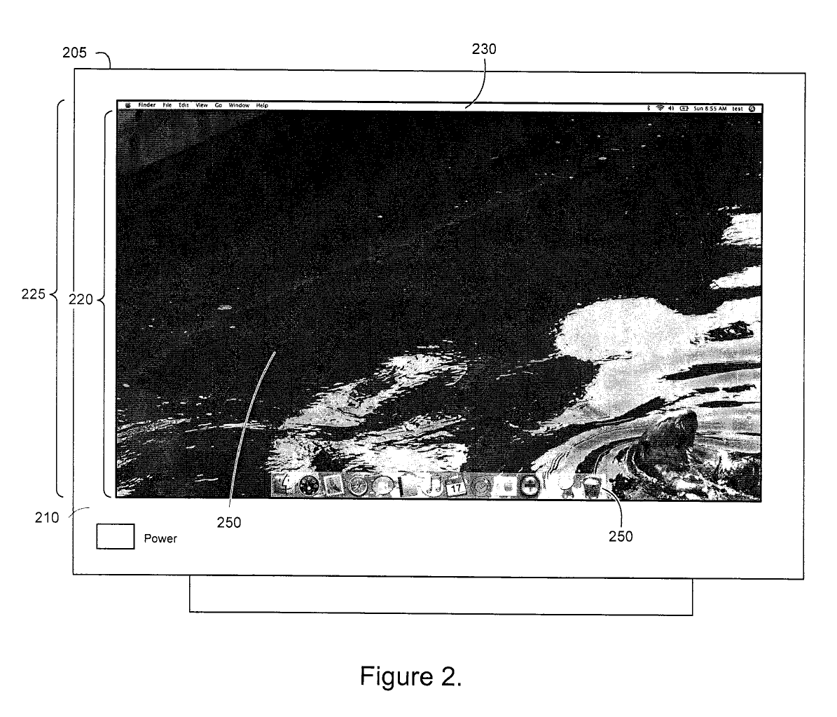

With reference to FIGS. 1 and 2, a flow diagram for an exemplary process 100 of manipulating an exemplary desktop background (e.g., desktop background 250 of FIG. 2) are shown. A desktop background is an image associated with and displayed on the desktop of a graphical user interface (GUI) associated with a device (e.g., desktop background 250 of FIG. 2). The GUI is presented on a device (e.g., personal computer, laptop, personal digital assistant, cell phone, media player such as an Apple iPod, etc.) having an output display (e.g., a television, a monitor, an imbedded LCD display, etc.). An image includes image data and can be of the form of a graphics object (including a solid or patterned object), a photograph, or other data. The image can change over time automatically or under the control of a user. The desktop background is typically displayed over a display space (e.g., display space 220 of FIG. 2). In some implementations, the display space is equal to the maximum display area (e.g., display area 225 of FIG. 2) of an associated display device.

### Desktop Environment

FIG. 2 shows an exemplary desktop display environment. The display of the desktop occurs on a display device 205. The display device 205 is capable of displaying image data within a particular fixed display area 225. The dimension of the display space 220 and the display device 205 can differ (i.e., in the presence of a bezel 210 surrounding the display space). A user's desktop is displayed within the display space 220 provided by the display device 205.

In FIG. 2, the display area 225 includes both a menu bar 230 and the display space 220 where a GUI environment is displayed. The GUI environment includes a desktop background 250 as well as other desktop items having a visual representation (e.g., icons 250, windows, etc.) which can occlude parts of the background.

### Desktop Background Manipulation Process

FIG. 1 is a flow diagram of an exemplary desktop manipulation process 100. The process 100 allows a user to select and manipulate a desktop background image for presentation in the user's display space as the desktop background.

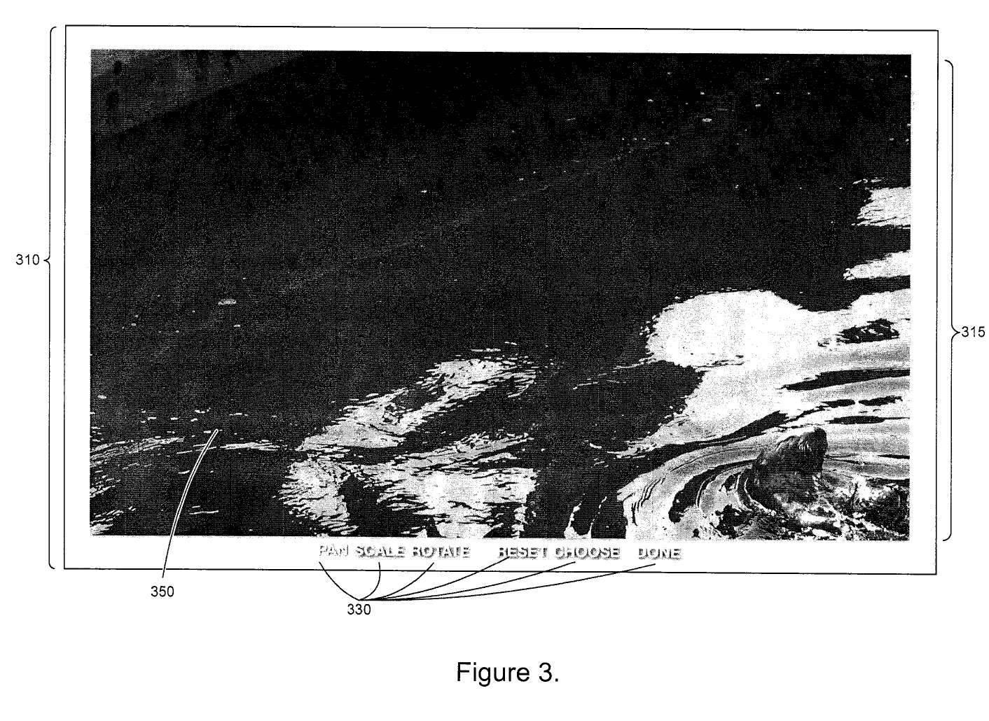

The process includes receiving or identifying a trigger to display an interface (110). The interface can be used to select and manipulate the image data to be displayed in the desktop background. In one implementation, the interface is an arrangement of display and control elements by which the user is able to manipulate image data. An exemplary implementation of such an interface is shown in FIG. 3, and described in detail below. In one implementation the trigger to display the interface can include a key stroke or a key stroke combination on a keyboard input device. In another implementation, a trigger can include manipulating a pointer with a tracking input device, such as a mouse, to a particular location (e.g., to a corner of the screen) and, or selecting a particular desktop item (e.g., an icon, button or menu bar item). Yet another implement can receive a trigger from an audio input device (for example, an audible utterance given by the user).

In some implementations, a transition effect (120) can occur after the trigger is received/identified, but before the interface is displayed. Some implementations can provide a visual transition effect which would transform the desktop items currently being displayed (e.g., windows, icons, menu bars, etc.) and display only the desktop background image. One implementation of such an effect can include fading the desktop items away (e.g., made transparent or hidden) so that the desktop items no longer occlude the desktop background image. Another implementation can animate the current desktop items to, for example, appear to ‘slide’ off the display device. Some other implementations can provide alternative transition effects, by, for example, producing an audible signal.

Upon receiving/identifying the trigger, and optionally displaying a transition effect, the interface for displaying and manipulating the desktop background is displayed (130). In one implementation, the interface displays the current desktop background image in a fixed-size, and in one implementation substantially full-screen (e.g., proportionately large) relative to the total display space 310. In one implementation, the desktop background image is displayed exactly as it would be when normally displayed as the desktop of the GUI (as in FIG. 2) having the same proportionate dimensions, aspect ration, etc. In some implementations, the desktop background image can be scaled (e.g., as in FIG. 3) or cropped slightly, while still being displayed at substantially full-screen, to allow a border to be drawn around the desktop background image during manipulation. As shown in FIG. 3, the exemplary interface has an area 315 in which a desktop background image is displayed. In one implementation, the size of the area displaying the desktop background image 315 cannot be changed by the user and the interface does not afford the ability to zoom or scroll the image other than by the mechanisms described below for transforming the image. Fixed-size, substantially-full-screen constraint implementations afford viewing a desktop background image in a manner that will very closely reflect how the desktop background will appear on the desktop.

In some implementations, the interface itself is modal. A modal interface is one which requires that the user interact with that interface rather than other parts of the system (i.e., other applications). A modal interface does not allow a user to ‘switch’ to another window or application, even if the GUI would otherwise allow it.

Continuing with the desktop background manipulation process, further input from the user is received (140). An implementation can receive input from a variety of physical input devices including but not limited to a keyboard, tracking device and audio input. Receiving user input can trigger one or more tools for manipulating a desktop background: a background image selector and a transformation tool.

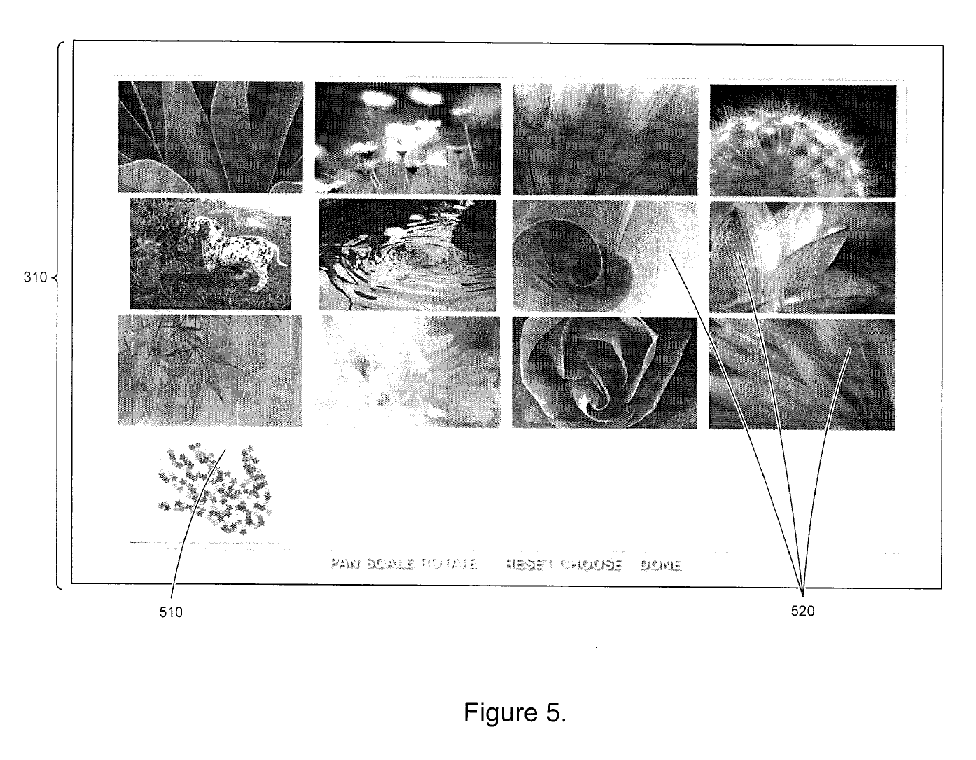

If a image selector tool is triggered, an image selector can be displayed (150). The image selector provides an interface for users to select an image as their desktop background. An exemplary interface showing numerous potential desktop backgrounds is shown in FIG. 5 and described in detail below. When a user has selected from among the display images, the selected image is displayed in the area 315 in the manipulation interface within the display space 310.

A displayed desktop background can be transformed (160) (e.g., by invoking a transformation tool) according to the input received from the user. In one implementation, the interface elements (e.g., buttons, hyperlinks, controls, etc.) with which the user can manipulate the desktop background image can be displayed along with the image. In one implementation interface elements are displayed in the border area between the desktop background image and the edge of the display space. In another implementation, the interface elements can be displayed as a floating toolbar or as interface elements that partially occlude (e.g., semi-transparent) the desktop background. In still another implementation, the interface can transform the desktop background image depending on only input from a tracking device (e.g., mouse). Yet another implementation, as exemplified in FIG. 3, can produce desktop background image transformation through a combination of interface elements and inputs (i.e., select pan, click and drag a mouse to move displayed desktop background image in the direction of mouse movement; select scale, click and drag a mouse to enlarge or shrink the desktop background image depending on whether the mouse movement is forward or backward). In one implementation, the interface can provide a variety of background desktop image transformations which can be executed given the appropriate input. For example, in one implementation the interface can provide the users with selectable transformations such as pan (move image left and right), scale (enlarge or shrink) and rotation. Some implementations can include image operations such as red-eye reduction, image tinting, captioning, blur, sepia-coloration, mosaic, filtering and other image manipulating effects. In some implementations, the interface can also provide a user with a way to reverse the transformations already made to the currently displayed desktop background image. For example ‘undo’ functionality can be provided in the interface to reverse the last transformation applied to the desktop background image. In some implementations, the interface can provide ‘reset’ to reverse all of the transformations applied to the desktop background image.

When user input is received to end desktop background image manipulation (i.e., by a user clicking on an interface button), a transition effect can again be displayed (170). The transition effect can be used to signal the end of the manipulation process 100. Some implementations can provide a visual transition effect that transforms the contents being displayed on the display device to hide interface elements related to desktop background image manipulation and to restore the desktop items that were formerly hidden. Such an effect can include fading the former desktop items back into view (e.g., from transparent to visible). Another implementation can show the former desktop items can be animated (e.g., appear to ‘slide’ onto the display device). Some other implementations can provide alternative transition effects, by, for example, producing an audible signal.

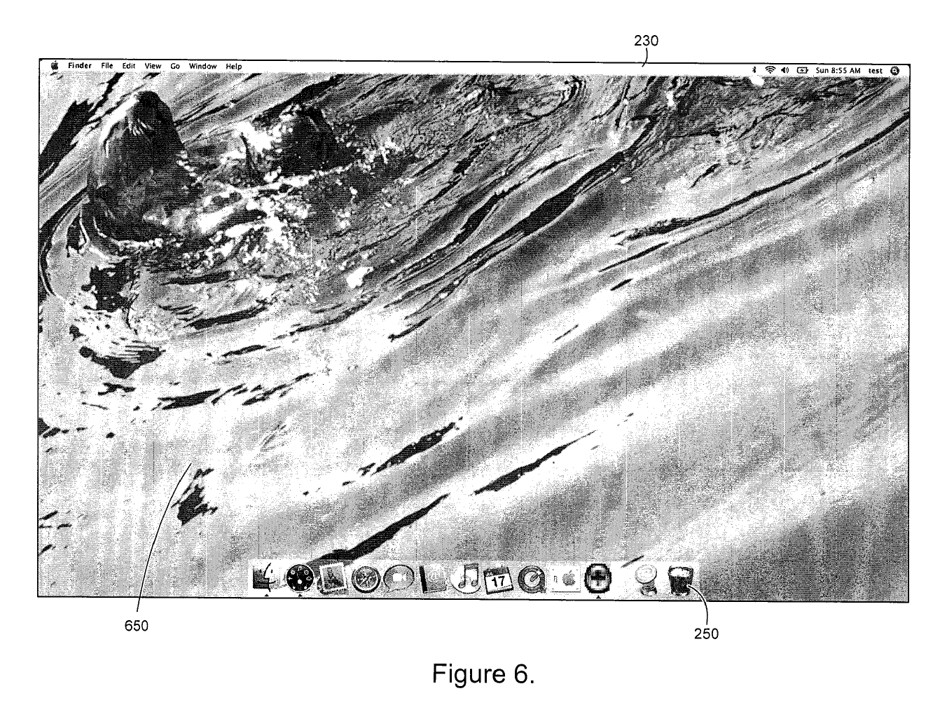

The final step of the desktop background manipulation process 100, is to restore the desktop (180). Restoring the desktop includes removing all interface elements related to desktop background image manipulation and restoring all desktop items that had formerly been hidden (see step 120). FIG. 6 below describes details for one implementation for updating the desktop background. In one implementation, the process provides a mechanism (e.g., a confirmation mechanism) to abort the manipulation process 100 so as to end the process without affecting the desktop background.

### Manipulation of Desktop Backgrounds

FIG. 3 illustrates an exemplary interface for manipulating a desktop background. Within the display space 310 the desktop background image 350 is displayed. When a new desktop background image is selected, or transformations on the desktop background image are performed, the desktop background image is updated within the display space 310 reflecting the desktop background's updated state. In some implementations, as in this exemplified implementation, the image space does not occupy the entire display space 310, although it does occupy a substantial portion of the entire display space 310. The exemplary interface also provides on-screen interface elements 330 with which a user can control how the desktop background is manipulated. In contrast to this particular implementation, one implementation can feature an image space identical to the display space. Such an implementation can provide on-screen interface elements which are displayed semi-transparently over parts of the desktop background image.

### Transformation of Desktop Backgrounds

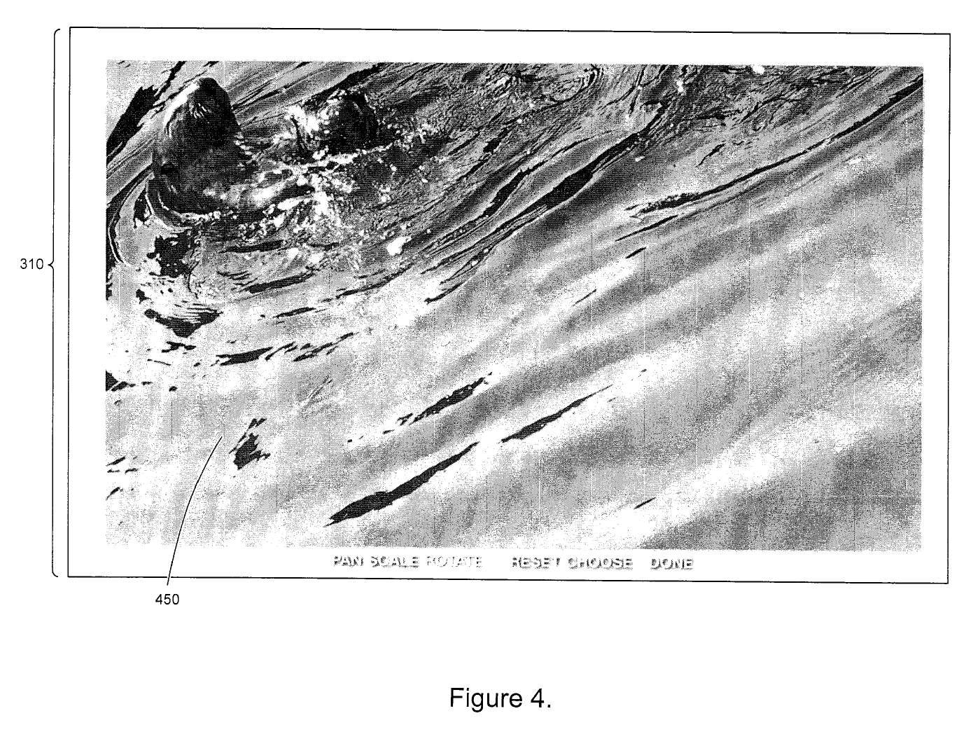

FIG. 4 shows the same interface displayed in FIG. 3 after a transform operation has executed to manipulate the desktop background image being displayed in the display space 310. If the user provides input to trigger a transformation operation, the desktop background shown in the display space 310 can be updated to immediately reflect the transformation being applied to the image. In this particular example, the desktop background image has provided input that pans and rotates the selected desktop background image. Panning and rotating the image changes the rotational orientation of the image and the portion of the image that is being displayed. Furthermore, if the user were to now trigger the end of the manipulation process (i.e., by clicking on ‘done’), the desktop background 250, would reflect the transformed desktop background image being displayed in the display space 310 (as illustrated in FIG. 6).

### Selecting New Images as the Desktop Background

FIG. 5 illustrates an exemplary interface 510 for picking new desktop images. The interface contains several images 520, where each image represents the content of a potential desktop background image from which the user can select to choose. In one implementation, the images shown can be images found on the users own personal computer's storage device. Another implementation, can display images from a remote location (i.e., accessible by network). Still another implementation, can display images that exist on a separate device such as a [digital] camera or cell phone. In one implementation, the interface is populated by images from multiple locations (e.g., all storage devices, images from documents and files, images available on a network such as the Internet) and allows the user to search for particular images (e.g., from a search interface such as Spotlight™ of Apple Computer Inc., Cupertino, Calif.). If the user provides input selecting a new desktop background from these images, that image is displayed as the desktop background image in the display space 310. Having selected a new background image, the user can provide further input to trigger further actions including: manipulating the new image, selecting a different image, transforming the selected image and exiting the interface In another implementation, a user can select multiple images. The desktop background image can be composed of the selected images, which can each be displayed in whole or in part. Each selected image can be independently positioned and transformed (i.e., cropped, positioned, rotated, scaled, filtered, etc.). Independent image transformations allows each image to be transformed without affecting other images in the display space. Transforming each image independently allows the user to achieve the desired arrangement and combination of images (e.g., as a collage of images). In one implementation, multiple selected images can be automatically transformed in the display space (e.g., by scaling and positioning each image in a grid).

### The Desktop Background Image Applied

FIG. 6 shows the same exemplary desktop display environment as captured in FIG. 2, except that the display environment's desktop background 650 reflects the desktop background image 450 illustrated in FIG. 4. The desktop background 650 looks substantially identical to the manipulated desktop background image 450 that is shown in FIG. 4 except that the interface elements are not displayed and the desktop items (e.g., menu bar 230 and icons 250) are displayed.

The invention and all of the functional operations described herein can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

To provide for interaction with a user, the invention can be implemented on a device having a display, e.g., a CRT (cathode ray tube) or LCD (liquid crystal display) monitor, for displaying information to the user and an input device, e.g., a keyboard, a mouse, a trackball, and the like by which the user can provide input to the computer. Other kinds of devices can be used to provide for interaction with a user as well; for example, feedback provided to the user can be any form of sensory feedback, e.g., visual feedback, auditory feedback provided by speakers associated with a device, externally attached speakers, headphones, and the like, or tactile feedback; and input from the user can be received in any form, including acoustic, speech, or tactile input.

The invention can be implemented in, e.g., a computing system, a handheld device, a telephone, a consumer appliance, a multimedia player or any other processor-based device. A computing system implementation can include a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, though three or four specific unit levels were described above in the context of the synthesis process, other numbers and kinds of levels can be used. Accordingly, other implementations are within the scope of the following claims.

What is claimed is:

1. A method comprising:
Identifying a trigger event;
Displaying an interface including an image associated with a background of a display environment, the image being displayed in substantially an entire display space of the display environment;
Receiving user input to either change or transform the image; and
Updating the background with the changed or transformed image.

2. The method of claim 1 where receiving input to transform the image includes input selected from the operations to scale, pan and rotate.

3. The method of claim 1 where receiving input to transform the image includes input to apply an image operation to the image selected from the group of red-eye reduction, image tinting, captioning, blur, sepia-coloration, mosaic, and filtering.

4. The method of claim 1 where the display environment is a desktop.

5. The method of claim 1 further comprising displaying one or more tools for selection by a user to allow for manipulation of the image.

6. The method of claim 5 where the tools are selected from the group comprising a selection tool and a transformation tool.

7. The method of claim 5 where the tools are overlaid on the image.

8. The method of claim 5 where the tools are displayed in a border area of the display environment.

9. The method of claim 1 further comprising responsive to receipt to change the image, selecting a one or more new images and displaying the one or more new images in substantially the entire display space.

10. The method of claim 9 further comprising receiving input to transform each one or more new images independently.

11. The method of claim 1 further comprising responsive to the receipt of transformation input transforming the image and displaying the transformed image in substantially the entire display space.

12. The method of claim 1 further comprising:
dismissing the interface; and
displaying the changed or transformed image displayed in the interface as the background.

13. The method of claim 1 where input to transform includes input to identify a portion of the image to be displayed in the background and the method further comprising presenting the portion in the background when the interface is dismissed.

14. The method of claim 13 where the input is a zoom input.

15. The method of claim 1 where displaying an interface includes a visual transition to introduce the interface.

16. The method of claim 12 where dismissing the interface includes a visual transition to dismiss the interface.

17. An apparatus comprising;
an interface for displaying an desktop image at a substantially a size and at an aspect ratio associated with an output device, the interface including:
a selection tool for selecting an image for display; and
a transformation tool for transforming the image prior to display.

18. A computer program product comprising instructions including instructions to cause a computing device to:
identify a trigger event;
display an interface including an image associated with a background of a display environment, the image being displayed in substantially an entire display space of the display environment;
receive user input to either change or transform the image; and
update the background with the changed or transformed image.
